(19) United States
(12) Patent Application Publication
(10) Pub. No.: US 2026/0087768 A1
(43) Pub. Date: Mar. 26, 2026

(54) HYPERSPACE DOWNSAMPLER

(71) Applicant: QUALCOMM Incorporated, San Diego, CA (US)

(72) Inventors: Shubham Deepak PATEL, Hyderabad (IN); Pawan Aasudaram BUDHWANI, Amravati (IN); Saikumar KONDAPARTHI, Hyderabad (IN)

(21) Appl. No.: 18/895,197

(22) Filed: Sep. 24, 2024

(51) Int. Cl. G06V 10/32; G06V 10/30; G06V 10/77; G06V 10/82

(52) U.S. Cl. CPC G06V 10/32; G06V 10/30; G06V 10/7715; G06V 10/82

(57) ABSTRACT

Systems and techniques are described herein for adjusting resolutions of input images. For example, a computing device can process an image to generate a feature map associated with spatio-channel data of the image. The computing device can generate, using a first encoder, a first feature weight map and a second feature weight map based on the spatio-channel data of the feature map. The computing device can apply a noise filter to the first feature weight map to generate a first downsampled feature weight map. The computing device can perform a selective pooling downsample of the second feature weight map to generate a second downsampled feature weight map. The computing device can generate, based on the first downsampled feature weight map and the second downsampled feature weight map, a reduced resolution representation of the image.

### FIELD

The present disclosure generally relates to adjusting resolutions of inputs. For example, aspects of the present disclosure relate to systems and techniques providing a hyperspace downsampler for adjusting resolution of input images.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment. Systems and devices increasingly have processing systems to process the information gathered to perform tasks, such as for route planning, navigation, collision avoidance, environment modelling/rendering, etc. One example of such a system includes vehicles equipped to perform Advanced Driver Assistance System (ADAS). In such systems, sensor data, such as images captured from one or more cameras, may be gathered, transformed, and analyzed to detect features and/or objects (e.g., targets). Performing ADAS functions using full resolution images can be computationally expensive.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for image downsampling is provide. The apparatus includes one or more memories configured to store one or more images and one or more processors coupled to the one or more memories and configured to: process an image of the one or more images to generate a feature map associated with spatio-channel data of the image; generate, using a first encoder, a first feature weight map and a second feature weight map based on the spatio-channel data of the feature map; apply a noise filter to the first feature weight map to generate a first downsampled feature weight map; perform a selective pooling downsample of the second feature weight map to generate a second downsampled feature weight map; and generate, based on the first downsampled feature weight map and the second downsampled feature weight map, a reduced resolution representation of the image.

In some aspects, a method for image downsampling is provided. The method includes: processing an image to generate a feature map associated with spatio-channel data of the image; generating, using a first encoder, a first feature weight map and a second feature weight map based on the spatio-channel data of the feature map; applying a noise filter to the first feature weight map to generate a first downsampled feature weight map; performing a selective pooling downsample of the second feature weight map to generate a second downsampled feature weight map; and generating, based on the first downsampled feature weight map and the second downsampled feature weight map, a reduced resolution representation of the image.

In some aspects, a non-transitory computer-readable medium is provided having stored thereon instructions that, when executed by at least one processor, cause the at least one processor to: process an image to generate a feature map associated with spatio-channel data of the image; generate, using a first encoder, a first feature weight map and a second feature weight map based on the spatio-channel data of the feature map; apply a noise filter to the first feature weight map to generate a first downsampled feature weight map; perform a selective pooling downsample of the second feature weight map to generate a second downsampled feature weight map; and generate, based on the first downsampled feature weight map and the second downsampled feature weight map, a reduced resolution representation of the image.

In some aspects, an apparatus for image downsampling is provide. The apparatus includes: means for processing an image to generate a feature map associated with spatio-channel data of the image; means for generating a first feature weight map and a second feature weight map based on the spatio-channel data of the feature map; means for applying a noise filter to the first feature weight map to generate a first downsampled feature weight map; means for performing a selective pooling downsample of the second feature weight map to generate a second downsampled feature weight map; and means for generating, based on the first downsampled feature weight map and the second downsampled feature weight map, a reduced resolution representation of the image.

In some aspects, one or more of the apparatuses described herein is, is part of, and/or includes a mobile device (e.g., a mobile telephone or other mobile device), a vehicle or a computing system, device, or component of a vehicle, an extended reality (XR) device or system (e.g., a virtual reality (VR) device, an augmented reality (AR) device, or a mixed reality (MR) device), a wearable device, a wireless communication device, a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus(es) described herein can include one or more cameras for capturing one or more images. In some aspects, the apparatus(es) described herein can include one or more displays for displaying one or more images, notifications, and/or other displayable data. In some aspects, the apparatus(es) described herein can include one or more sensors, such as one or more inertial measurement units (IMUs), one or more gyroscopes, one or more gyrometers, one or more accelerometers, any combination thereof, and/or other sensor).

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example image capture and processing system, in accordance with aspects of the present disclosure;

FIG. 2 illustrates an example implementation of a system-on-a-chip (SOC), in accordance with aspects of the present disclosure;

FIG. 3A illustrates an example of a fully connected neural network, in accordance with aspects of the present disclosure;

FIG. 3B illustrates an example of a locally connected neural network, in accordance with aspects of the present disclosure;

FIG. 3C illustrates an example of a convolutional neural network (CNN), in accordance with aspects of the present disclosure;

FIG. 3D illustrates an example of a deep convolutional network (DCN) for recognizing visual features from an image, in accordance with aspects of the present disclosure;

FIG. 4 illustrates an example of a vehicle with a sensor suite, in accordance with aspects of the present disclosure;

FIG. 5 illustrates an example hyperspace downsampler, in accordance with aspects of the present disclosure;

FIG. 6 illustrates an example block diagram of a hyperspace transform, in accordance with aspects of the present disclosure;

FIG. 7 illustrates an example block diagram of a spatial channel attention engine, in accordance with aspects of the present disclosure;

FIG. 8 illustrates an example block diagram of a weighted pooling engine and noise filter for spatial restoration, in accordance with aspects of the present disclosure;

FIG. 9 illustrates an example flow diagram for applying a hyperspace downsampler in a power saving mode, in accordance with aspects of the present disclosure;

FIG. 10 illustrates an example flow diagram for applying a hyperspace downsampler, in accordance with aspects of the present disclosure; and

FIG. 11 illustrates an example computing device architecture of an example computing device which can implement the various techniques described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As mentioned previously, systems and devices (e.g., autonomous vehicles, such as autonomous and semi-autonomous cars, drones, mobile robots, mobile devices, extended reality (XR) devices, and other suitable systems or devices) increasingly include multiple sensors (e.g., camera sensors) to gather information about the environment, as well as processing systems to process the information gathered, such as for route planning, navigation, collision avoidance, environment modelling/rendering, etc. Image processing or computer vision techniques (e.g., object detection, object classification, etc.) may require high resolution images to provide quality results. For example, object detection models (e.g., machine learning models, such as neural networks) require high resolution input images and intermediate feature representations for maximal detection performance, which can result in a computationally expensive solution. Alternatively, downsampled input images (or low-resolution images from a lower-resolution sensor) and/or reduced resolution feature representations can be used to reduce computational costs for object detection. The reduced computational cost of using current downsampling techniques of input images generally comes at the expense of detection performance.

Current downsampling techniques of images may include reducing the resolution of the images. Image processing or computer vision techniques (e.g., object detection, object classification, semantic segmentation, pose estimation, etc.) are less accurate when using reduced resolution images at least because the reduced resolution images generally include fewer distinguishable features, higher noise, and more domain shift issues as compared to higher resolution images. The fewer number of distinguishable features can cause machine learning models to operate with reduced accuracy when receiving reduced resolution images as inputs.

Accuracy in object detection and other computer vision or image processing techniques is especially important when performed in the context of controlling a moving vehicle (e.g., autonomous or semi-autonomous car, drone, mobile robot, etc.) where errors in accuracy can have catastrophic ramifications. For example, Advanced Driver Assistance System (ADAS) in autonomous and semi-autonomous vehicles requires a continuous or near continuous feed of a multi-camera stream of images to perform tasks such as cruise control, collision warning, lane assist, driver monitoring, in-cabin sensing, etc. Performing all of the above tasks at a speed necessary to safely control a moving vehicle is computationally expensive and generally requires a dedicated processing unit for many of the tasks. Techniques that reduce computational costs while preserving accuracy expands the types of processing units that can be used to perform the tasks, allowing for lower cost or more readily available processing units to be used.

Not every pixel of an image is relevant to a device performing various vehicle tasks, such as cruise control, collision warning, lane departure, etc. For example, the pixels of an image including pictures of the sky or off-road objects generally are not relevant to a device performing a task such as lane assist. Downsampling an image while preserving the features relevant to a machine learning model for performing a task can result in performance of the tasks at reduced computational costs while preserving accuracy.

Systems, apparatuses, electronic devices, methods (also referred to as processes), and computer-readable media (collectively referred to herein as “systems and techniques”) are described herein for downsampling input images. In some aspects, the systems and techniques can include using a hyperspace downsampler to transform incoming input streams (e.g., streams of images) from a higher resolution to a reduced resolution, such as by identifying and boosting key input features of the images that correspond to input priors of a target system. The systems and techniques are applicable to any system that has a loss function associated with it to measure output quality. In some aspects, the target system can include a target machine learning model (e.g., a target deep neural network (DNN), deep convolutional network (DCN), etc.), a display renderer engine, a video codec engine, any combination thereof, and/or other type of system.

In some aspects, the hyperspace downsampler can be used to perform weighted feature boosting and downsampling in hyperspace projection of inputs (e.g, images, image streams, and other inputs). The hyperspace downsampler can include learnable non-linear hyperspace parameters making the hyperspace downsampler adaptable for target use cases, such as performing ADAS tasks. In some aspects, the hyperspace downsampler is adaptable to a target system (e.g., machine learning model, display renderer engine, video codec engine, and/or other type of system) by performing spatial channel attention to assign scores to features of images used by the target system (e.g., machine learning model or other type of system) to perform a task. The hyperspace downsampler can use various filtering techniques such as convolutional range-gaussian filtering to reduce noise from hyperspace maps using feature weight maps (e.g., a self-attentive token map generated by a spatial channel attention engine or layer).

In some aspects, the hyperspace downsampler can have a module-based architecture with a hyperspace transformation engine, a spatial channel attention engine, a noise filter, a weighted pooling engine, and a spatial restoration engine being discrete modules or engines. In some aspects, the hyperspace downsampler can have a multi-layered architecture including various layers such as a hyperspace transformation layer, a spatial channel attention layer, a noise filter layer, a weighted pooling layer, and a spatial restoration layer.

In some aspects, the hyperspace downsampler can receive a higher resolution input, such as one or more images, at the hyperspace transformation engine. The hyperspace transformation engine can perform a Space2Depth (S2D) transformation to shift pixel arrangements of the one or more images across channels as patches. The hyperspace transformation engine can perform a 2D convolution operation (e.g., Conv2d) of the patches, the results of which can be applied to an activation function (e.g., a rectified linear unit (ReLU)) to generate hyperspace maps (e.g., feature maps) based on the shifted pixel arrangements. In some examples, the hyperspace transformation engine can include multiple Conv2d and ReLU pairs to generate the hyperspace maps. The hyperspace maps can represent the spatio-channel data of the one or more images. The S2D transformation and the Conv2d and ReLU operations can be performed by the hyperspace transformation engine. The output of the hyperspace transformation engine can include the hyperspace maps based on the shifted pixel arrangements.

The spatial channel attention engine of the hyperspace downsampler can receive the hyperspace maps. The spatial channel attention engine can analyze features of the hyperspace maps to determine relationships of the features. For example, the spatial channel attention engine can perform a spatial channel attention (e.g., dual attention) operation along spatial and channel dimensions of the patches from the Space2Depth (S2D) transformation. The spatial channel attention operation can include analyzing features to learn relationships between patches. The hyperspace downsampler can generate a saliency map (e.g., feature weight maps) based on the patches. The saliency map can represent features of the hyperspace map that are relevant to the target system (e.g., machine learning model or other type of system) in performing a task (e.g., object detection, semantic segmentation, pose estimation, and/or other task(s)) as values from 0.0 to 1.0. For example, the spatial channel attention engine can assign higher scores to features of the hyperspace map that are relevant to the target system (e.g., machine learning model or other type of system) for generating accurate predictions or performing tasks. The spatial channel attention engine can assign lower scores to less relevant features. In some examples, the spatial channel attention engine can ignore or otherwise remove features associated with the lower scores.

In some aspects, the spatial channel attention engine is fine-tuned based on the system (e.g., machine learning model or other type of system). For example, the fine tuning can include using a backpropagation algorithm, loss function, or other training algorithm/function to fine tune parameters of the spatial channel attention engine to assign higher scores to features relevant to the task performed by the target system (e.g., machine learning model or other type of system). The spatial channel attention engine can be fine-tuned for particular systems (e.g., machine learning models or other type of systems). The spatial channel attention engine can be finetuned according to the target system (e.g., machine learning model or other type of system) during on-device or off device training.

In some aspects, the spatial channel attention engine can include a spatial attention block and a channel attention block. The spatial attention block can analyze features in high frequency regions of the hyperspace maps using max pooling techniques. In some examples, the spatial attention block can analyze features of low frequency regions of the hyperspace maps using average pooling techniques. In some examples, the channel attention block can apply global average pooling techniques to generate a feature weight map (e.g., a saliency map) for channels. For instance, the channel attention block can aggregate spatial information of each feature map into values (e.g., by aggregating a group of values in a feature map into a single value) to serve as channel descriptors. The channel descriptors can summarize the importance of each channel, making it easier to emphasize more important channels from the less important channels. In some cases, the channel attention block can include one or more learnable 1×1 convolutions (e.g., adjustable 1×1 convolutions during training) and a sigmoid across channels to generate channel feature weight maps. The channel attention block or spatial channel attention layer can multiply the feature weight map with input features from the hyperspace map to generate enhanced features for subsequent engines or layers of the hyperspace downsampler.

The noise filter can perform various dilated convolutions and filtering techniques on the hyperspace maps to reduce adversarial noise and outlier noise from the hyperspace maps to downsample the hyperspace maps. In some examples, the noise filter layer applies convolutional range-gaussian filtering by using a feature weight map from the spatial channel attention engine to cover outliers and adversarial noise.

The weighted pooling engine can perform a feature boosting operation by using the spatial channel attention feature weight maps to perform selective pooling downsampling of the feature weight maps. The weighted pooling engine can use adaptive thresholding on frequency components of the feature weight maps and the hyperspace map. In some examples, the weighted pooling engine can downsample the hyperspace map using a pointwise convolution (e.g., a 1×1 convolution) with the feature weight map. In some examples, the weighted pooling engine can use the 1×1 convolution to generate reduced resolution image dimensions for the target system (e.g., machine learning model or other type of system).

The spatial restoration engine can receive concatenated hyperspace maps of the noise filter and the weighted pooling engine. The spatial restoration layer can process the concatenated feature weight maps to transform the concatenated hyperspace maps into a spatial dimension using a Depth2Space (D2S) operation. The spatial restoration layer can use the Depth2Space operation to generate a reduced resolution image for the target system (e.g., machine learning model or other type of system) based on the concatenated hyperspace maps. The target system (e.g., machine learning model or other type of system) can receive the reduced resolution image to perform a task, such as various ADAS functions (e.g., automatic parking, object detection, cruise control, etc.), image generation functions, object detection, semantic segmentation, pose estimation, display rendering functions, video coding/compression functions, and/or other functions or tasks.

While aspects described herein include examples applying the hyperspace downsampler to machine learning systems or models, the hyperspace downsampler can be applied to any type of system associated with a loss function used to measure output quality of the system. For example, the hyperspace downsampler can be fine-tuned for a display renderer engine and/or a video codec engine to downsample input frames (from original high-resolution frames to downsampled frames), where quality of the downsampled frames can be assessed with one or more loss functions, such as mean-squared error (MSE), peak-signal-to-noise ratio (PSNR), and/or other loss function with respect to the original high-resolution frames.

Various aspects of the present disclosure will be described with respect to the figures.

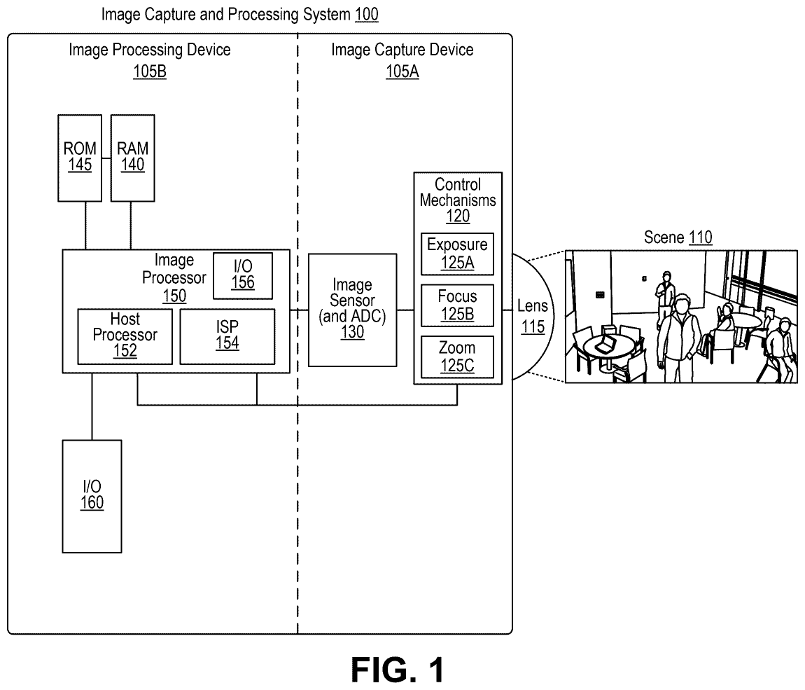

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses can be included in the image capture and processing system 100, such as one or more microlenses over each photodiode of the image sensor 130, which each bend the light received from the lens 115 toward the corresponding photodiode before the light reaches the photodiode. The focus setting can be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective covers that block light from reaching certain photodiodes, or portions of certain photodiodes, at certain times and/or from certain angles. In some cases, opaque and/or reflective covers may be used for phase detection autofocus (PDAF). In some cases, the opaque and/or reflective covers may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

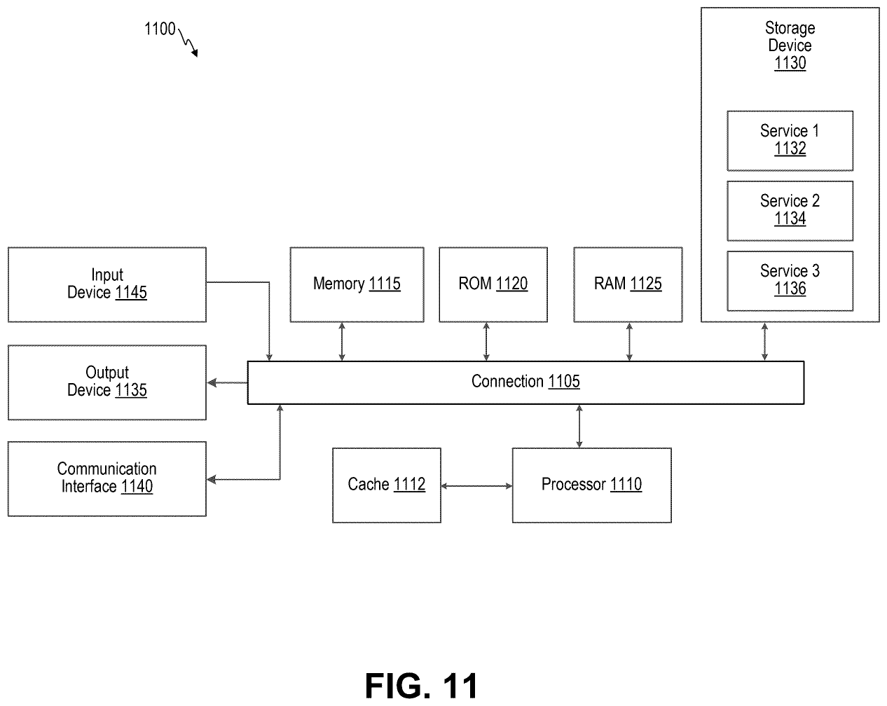

The image processor 150 may include one or more processors, such as one or more image signal processors (ISPs) (including ISP 154), one or more host processors (including host processor 152), and/or one or more of any other type of processor 1010 discussed with respect to the computing system 1100 of FIG. 11. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

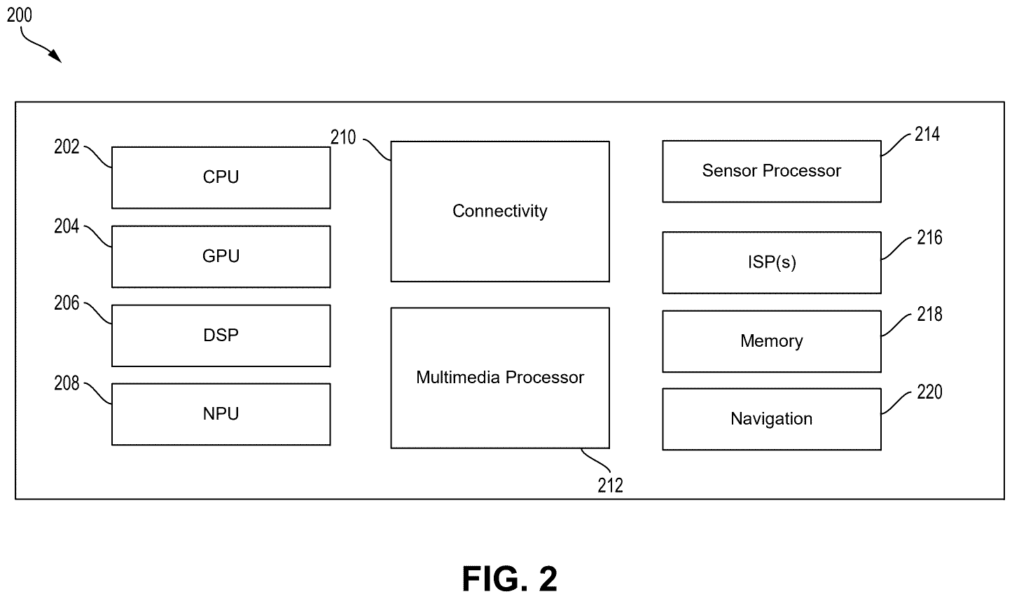

In some examples, the system-on-a-chip (SOC) 200 of FIG. 2 can include the image capture and processing system 100, the image capture device 105A, the image processing device 105B, or a combination thereof.

FIG. 2 illustrates an example implementation of a system-on-a-chip (SOC) 200, which may include a central processing unit (CPU) 202 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 208, in a memory block associated with a CPU 202, in a memory block associated with a graphics processing unit (GPU) 204, in a memory block associated with a digital signal processor (DSP) 206, in a memory block 218, and/or may be distributed across multiple blocks. Instructions executed at the CPU 202 may be loaded from a program memory associated with the CPU 202 or may be loaded from a memory block 218.

The SOC 200 may also include additional processing blocks tailored to specific functions, such as a GPU 204, a DSP 206, a connectivity block 210, which may include fifth generation (5G) connectivity, fourth generation long term evolution (4G LTE) connectivity, Wi-Fi connectivity, USB connectivity, Bluetooth connectivity, and the like, and a multimedia processor 212 that may, for example, detect and recognize gestures. In one implementation, the NPU is implemented in the CPU 202, DSP 206, and/or GPU 204. The SOC 200 may also include a sensor processor 214, image signal processors (ISPs) 216, and/or navigation module 220, which may include a global positioning system.

The SOC 200 may be based on an ARM instruction set. SOC 200 and/or components thereof may be configured to perform segmentation mask extrapolation. For example, the CPU 202, DSP 206, and/or GPU 204 may be configured to perform tasks (e.g., object detection, semantic segmentation, pose estimation, and/or other task(s)) using a visual language model via latent feature adaptation with synthetic data.

In some cases, the SOC 200 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics

In some cases, sensor data, such as images captured by the image capture and processing system 100, point clouds captured by Light Detection and Ranging (LIDAR) and/or Radio Detection and Ranging (RADAR) sensors, etc., may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

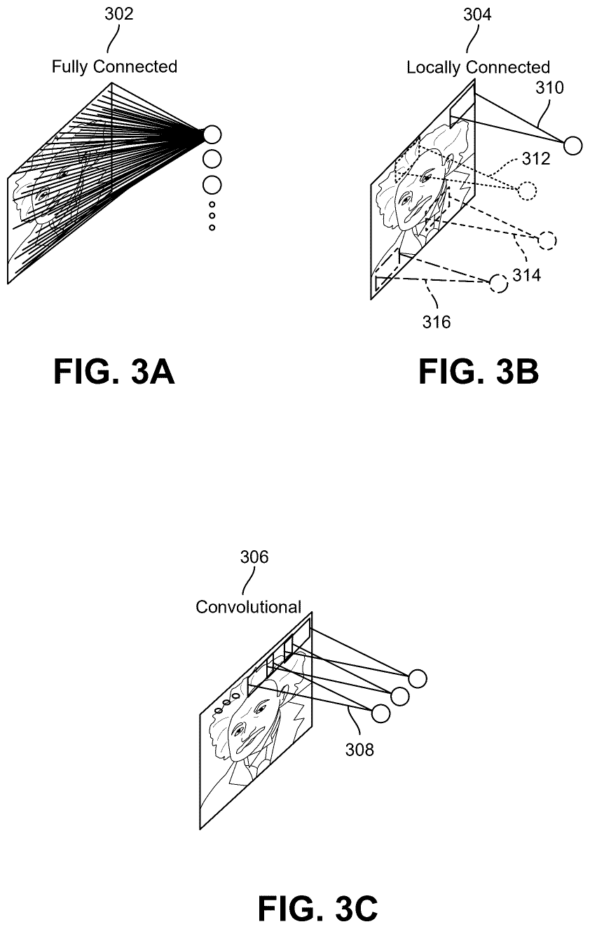

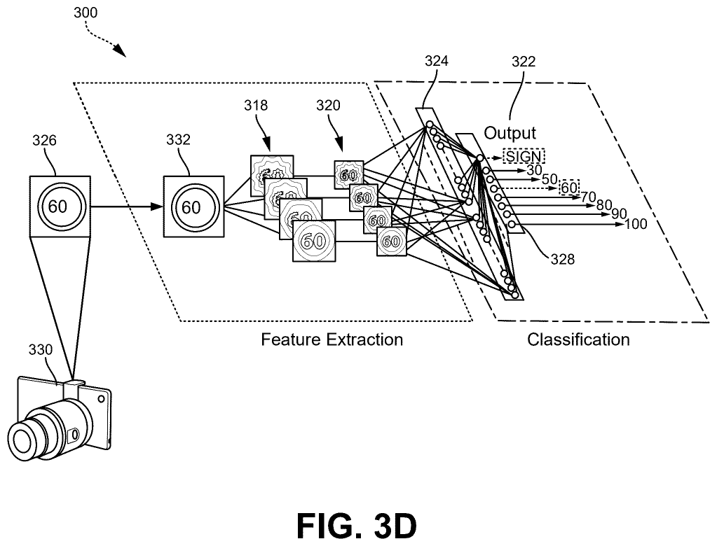

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 3A-FIG. 3D.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 3A illustrates an example of a fully connected neural network 302. In a fully connected neural network 302, a neuron in a first layer may communicate its output to every neuron in a second layer, so that each neuron in the second layer will receive input from every neuron in the first layer. FIG. 3B illustrates an example of a locally connected neural network 304. In a locally connected neural network 304, a neuron in a first layer may be connected to a limited number of neurons in the second layer. More generally, a locally connected layer of the locally connected neural network 304 may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 3C illustrates an example of a convolutional neural network 306. The convolutional neural network 306 may be configured such that the connection strengths associated with the inputs for each neuron in the second layer are shared (e.g., 308). Convolutional neural networks may be well suited to problems in which the spatial location of inputs is meaningful. Convolutional neural network 306 may be used to perform one or more aspects of video compression and/or decompression, according to aspects of the present disclosure.

One type of convolutional neural network is a deep convolutional network (DCN). FIG. 3D illustrates a detailed example of a DCN 300 designed to recognize visual features from an image 326 input from an image capturing device 330, such as an image capture and processing system 100 of FIG. 1. The DCN 300 of the current example may be trained to identify traffic signs and a number provided on the traffic sign. Of course, the DCN 300 may be trained for other tasks, such as identifying lane markings or identifying traffic lights.

The DCN 300 may be trained with supervised learning. During training, the DCN 300 may be presented with an image, such as the image 326 of a speed limit sign, and a forward pass may then be computed to produce an output 322. The DCN 300 may include a feature generation (or extraction) section and a classification section. Upon receiving the image 326, a convolutional layer 332 may apply convolutional kernels (not shown) to the image 326 to generate a first set of feature maps 318. As an example, the convolutional kernel for the convolutional layer 332 may be a 5×5 kernel that generates 28×28 feature maps. In the present example, because four different feature maps are generated in the first set of feature maps 318, four different convolutional kernels were applied to the image 326 at the convolutional layer 332. The convolutional kernels may also be referred to as filters or convolutional filters.

The first set of feature maps 318 may be subsampled by a max pooling layer (not shown) to generate a second set of feature maps 320. The max pooling layer reduces the size of the first set of feature maps 318. That is, a size of the second set of feature maps 320, such as 14×14, is less than the size of the first set of feature maps 318, such as 28×28. The reduced size provides similar information to a subsequent layer while reducing memory consumption. The second set of feature maps 320 may be further convolved via one or more subsequent convolutional layers (not shown) to generate one or more subsequent sets of feature maps (not shown).

In the example of FIG. 3D, the second set of feature maps 320 is convolved to generate a first feature vector 324. Furthermore, the first feature vector 324 is further convolved to generate a second feature vector 328. Each feature of the second feature vector 328 may include a number that corresponds to a possible feature of the image 326, such as “sign,” “60,” and “100.” A softmax function (not shown) may convert the numbers in the second feature vector 328 to a probability. As such, an output 322 of the DCN 300 is a probability of the image 326 including one or more features.

In the present example, the probabilities in the output 322 for “sign” and “60” are higher than the probabilities of the others of the output 322, such as “30,” “40,” “50,” “70,” “80,” “90,” and “100”. Before training, the output 322 produced by the DCN 300 is likely to be incorrect. Thus, an error may be calculated between the output 322 and a target output. The target output is the ground truth of the image 326 (e.g., “sign” and “60”). The weights of the DCN 300 may then be adjusted so the output 322 of the DCN 300 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. The aforementioned manner of adjusting the weights can be referred to as “back propagation” as back propagation involves a “backward pass”through the neural network.

In practice, the error gradient of weights may be calculated over a small number of examples, so that the calculated gradient approximates the true error gradient. The approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 322 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 320) receiving input from a range of neurons in the previous layer (e.g., feature maps 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

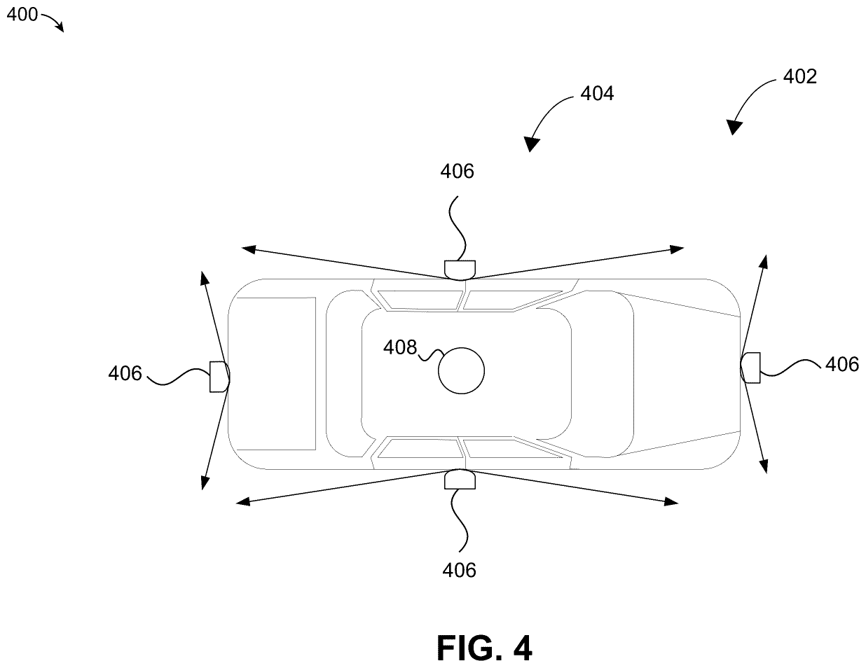

FIG. 4 is a diagram illustrating an example of a vehicle (e.g., an autonomous vehicle) 402 with a sensor suite 404. The source sensor suite 404 is shown to include four cameras 406 and one Light Detection and Ranging (LIDAR) sensor 408. Each of the cameras 406 may be a surround view (SV) camera or a fisheye camera, for example, with a wide (e.g., nearly 180 degree) field of view. The LIDAR sensor 408 may be a 64-layer LIDAR sensor. In one or more examples, the source sensor suite 404 of the source vehicle 402 may include a greater or lower number of cameras 406 and/or LIDAR sensors 408, than as shown in FIG. 4.

Collectively, the source sensor suite 404 may have certain intrinsic parameters (e.g., focal lengths of the cameras 406, optical centers of the cameras 406, skew coefficients of the cameras 406, frame-capture rates of the cameras 406, scan patterns of the LIDAR sensor 408, and/or intensity channels of the LIDAR sensor 408) and certain extrinsic parameters (e.g., positions of the cameras 406 and the LIDAR sensor 408 on source vehicle 402).

Data from at least a portion of the source sensor suite 404 may be used to train machine-learning models to perform specific tasks such as various ADAS tasks (e.g., automatic parking, object detection, semantic segmentation, pose estimation, cruise control, etc.).

As previously mentioned, increasingly systems and devices (e.g., autonomous vehicles, such as autonomous and semi-autonomous cars, drones, mobile robots, mobile devices, extended reality (XR) devices, and other suitable systems or devices) include multiple sensors (e.g., camera sensors) to gather information about the environment, as well as processing systems to process the information gathered, such as for route planning, navigation, collision avoidance, environment modelling/rendering, etc. Perception models (e.g., object detection models, semantic segmentation models, pose estimation models, among others) may require high resolution input images and intermediate feature representations for maximal detection performance, which can result in a computationally expensive solution. Alternatively, downsampled input images (or low-resolution images from a lower-resolution sensor) and/or reduced resolution feature representations can be used to reduce computational costs for such tasks (e.g., object detection, semantic segmentation, pose estimation, and/or other task(s)). The reduced computational cost of using current downsampling techniques of input images generally comes at the expense of perception performance.

In one or more aspects, the systems and techniques provide a computationally efficient technique of reducing resolution of inputs (e.g., input images) while preserving features relevant to a target machine learning model. By preserving or boosting features relevant to the target machine learning model, the hyperspace downsampler can reduce computational costs by reducing the resolution of inputs received by the target machine learning model.

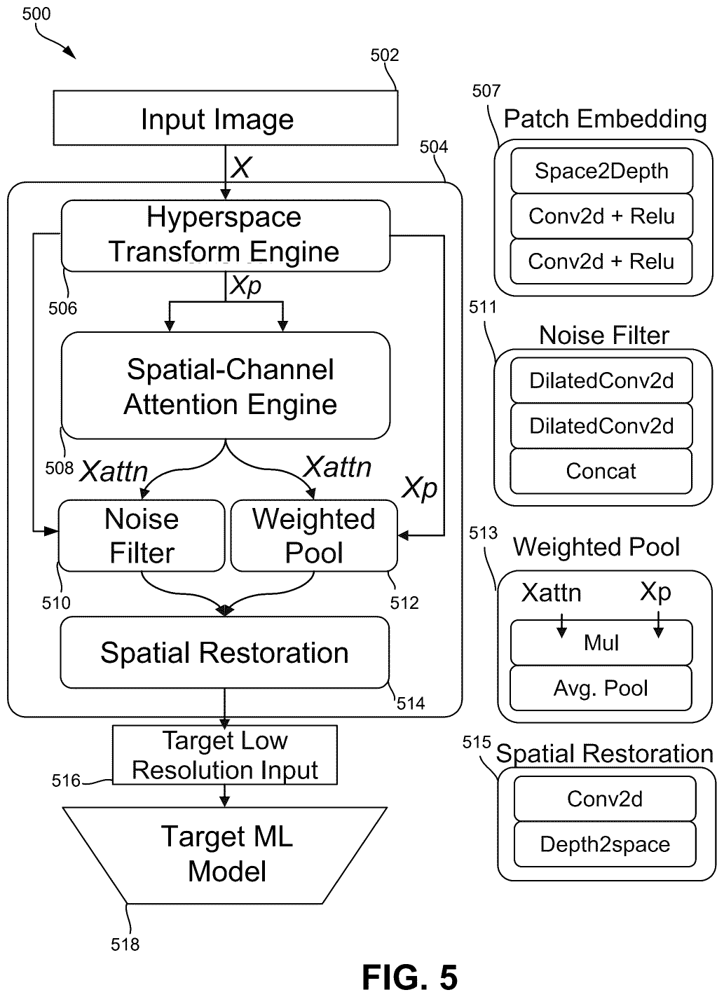

FIG. 5 illustrates an example block diagram 500 of a hyperspace downsampler 504. The block diagram 500 includes receiving an input image 502 at the hyperspace downsampler 504. The input image 502 can be a stream of images, such as a stream of images captured by a camera. In some examples, the hyperspace downsampler 504 can receive other inputs, such as sensor data from the source sensor suite 404 of FIG. 4.

The hyperspace downsampler 504 receives the input image 502. The hyperspace downsampler 504 can perform a hyperspace transform on the input image 502 using a hyperspace transform engine 506. The hyperspace transform engine 506 processes the input image 502 to generate a hyperspace map (Xp) representing the spatio-channel data of the input image 502. The hyperspace transform engine 506 can use a Space2Depth (S2D) transformation to shift pixel arrangements of the one or more images across channels as patches. The hyperspace transform engine 506 can perform a 2D convolution operation (e.g., Conv2d) and apply an activation function (e.g., using a rectified linear unit (ReLU)) on the patches to generate the hyperspace map (e.g., feature map) based on the shifted pixel arrangements.

Patch embedding 507 represents an example multi-layered architecture of the hyperspace transform engine 506. For example, the patch embedding includes a Space2Depth layer and two 2D convolution layers with corresponding ReLUs. The Space2Depth layer redistributes spatial information of pixel arrangements of the input image 502 into a depth dimension of the hyperspace map. The Space2Depth can reduce spatial dimensions of the input image 502 and increase the number of channels associated with the input image 502. The two 2D convolution layers with corresponding ReLUs can extract features from the output of the Space2Depth operation to generate the hyperspace map.

A spatial channel attention engine 508 can receive the hyperspace map (Xp). In some aspects, the spatial channel attention engine 508 can include or can be an encoder. The spatial channel attention engine 508 can generate feature weight maps (e.g., saliency maps) for the various channels. For instance, the channel attention block can aggregate spatial information of each feature map into values (e.g., by aggregating a group of values in a feature map into a single value) to serve as channel descriptors. The channel descriptors can summarize the importance of each channel, making it easier to emphasize more important channels from the less important channels. For example, the spatial channel attention engine 508 can analyze features of the hyperspace map to determine relationships of the features. In some cases, the spatial channel attention engine 508 can perform a spatial channel attention operation of the hyperspace map to determine relationships of features of the hyperspace map. The spatial channel attention engine 508 can generate feature weight maps representing the relevancy of features of the input image 502 to a target machine learning model 518.

The feature weight maps represent features of the hyperspace map that are relevant to the target machine learning model in performing a task. For example, the hyperspace downsampler can assign higher scores to features of the hyperspace map that are relevant to the accuracy of predictions generated by the target machine learning model 518. In one example, the target machine learning model can be trained to read signs on the side of a road. In such an example, the spatial channel attention engine 508 can assign higher scores to features of the hyperspace map indicative of features associated with a sign (e.g., text, reflective coatings indicative of a sign, colors indicative of a sign, etc.) The spatial channel attention engine 508 can assign lower scores to less relevant features. In continuing the example of the target machine learning model 518 for reading signs, the spatial channel attention engine 508 can assign lower scores to features of the hyperspace map irrelevant or less relevant to the task of reading signs, such as features associated with the sky, the road, foliage, etc.

The spatial channel attention engine 508 can be fine-tuned based on the target machine learning model 518. For example, the fine tuning can include using a backpropagation algorithm, loss function, or other training algorithm/function to fine-tune parameters of the spatial channel attention engine 508. The spatial channel attention engine 508 is fine tuned to identify features relevant to the target machine learning model 518 from the hyperspace map. In further examples, the spatial channel attention engine is fine-tuned to assign higher scores to features relevant to the task performed by the target machine learning model and lower scores to the features less relevant to the task. The spatial channel attention engine 508 can be fine-tuned for particular machine learning models. For example, the spatial channel attention engine 508 can operate using different parameters when performing spatial channel attention operations for a first machine learning model as compared to performing spatial channel attention operations for a second machine learning model.

A noise filter 510 can receive the feature weight map generated by the spatial channel attention engine 508 and the hyperspace map generated by the hyperspace transform engine 506. The noise filter 510 can receive the feature weight map and perform various dilated convolutions (e.g., of different dilation rates, such as dilation rates of 3, 5, 7, etc.) and filtering techniques to reduce noise from the hyperspace maps. In some examples, the noise filter layer applies convolutional range-gaussian filtering by using a feature weight map from the spatial channel attention engine 508 to cover outliers and adversarial noise of the feature map.

Noise filter architecture 511 provides an example layer architecture of the noise filter 510. By way of example, the noise filter architecture 511 includes two dilatedConv2d layers to downsample the hyperspace map. The noise filter architecture 511 includes a concatenation layer to perform concatenation on the downsampled hyperspace map (e.g., also referred to as a downsampled feature map) to be used by a spatial restoration engine 514 to generate a reduced resolution image associated with the input image 502.

A weighted pooling engine 512 can perform a feature boosting operation by using the spatial channel attention feature weight maps (Xattn) to perform selective pooling downsampling of the feature weight maps thereby boosting features associated with higher values of the feature weight map. The weighted pooling engine 512 can use adaptive thresholding on frequency components of the feature weight maps and hyperspace map to perform selective pooling downsampling. The weighted pooling engine 512 can generate a downsampled output by applying the feature weight map (Xattn) to the hyperspace map (Xp). In some examples, the weighted pooling layer can downsample the hyperspace map or feature weight map using a pointwise convolution (e.g., a 1×1 convolution).

Weighted pooling architecture 513 provides an example layer architecture of the weighted pooling engine 512. The weighted pooling architecture 513 includes a multiplication layer (Mul) to perform a pointwise multiplication of the feature weight map (Xattn) and the hyperspace map (Xp) to apply attention weights of the feature weight map to the hyperspace map. The output of the multiplication is provided to an average pooling layer which the weighted pooling architecture 513 can downsample.

A spatial restoration engine 514 receives concatenated hyperspace maps of the noise filter layer and the weighted pooling layer. The spatial restoration engine 514 can process the concatenated hyperspace maps to reconstruct a reduced resolution image (e.g., target low resolution input 516) representing a reduced resolution representation of the input image 502. The spatial restoration engine 514 can use spatial restoration architecture 515 to perform a 2D convolution (e.g., Conv2d) layer and a Depth2space operation to process the concatenated downsampled hyperspace maps from the noise filter 510 and the downsampled feature weight maps of the weighted pooling architecture 513. The Depth2Space (D2S) operation generates a target low resolution input 516 (e.g., a reduced resolution image).

The target low resolution input 516 is reduced in resolution compared to the input image 502. Features of the target low resolution input 516 relevant to the task to be performed by the target machine learning model 518 are boosted from the weighted pooling engine 512. The target machine learning model 518 can receive the target low resolution input and perform a task (e.g., object detection, semantic segmentation, pose estimation, and/or other task(s) for objects represented in the target low resolution input 516).

In some aspects, training of the target machine learning model 518 or neural networks described herein (e.g., the neural networks of FIGS. 3A-3D, among various other machine learning networks described herein) can be performed using online training (e.g., in some case on-device training), offline training, and/or various combinations of online and offline training. In some cases, online can refer to time periods during which the input data (e.g., such as the sensor data, images, masks) is processed, for example for performance of optimizing loss weights of the loss function to reduce losses while maintaining accuracy of the neural network. In some examples, offline can refer to idle time periods or time periods during which input data is not being processed. Additionally, offline can be based on one or more time conditions (e.g., after a particular amount of time has expired, such as a day, a week, a month, etc.) and/or can be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

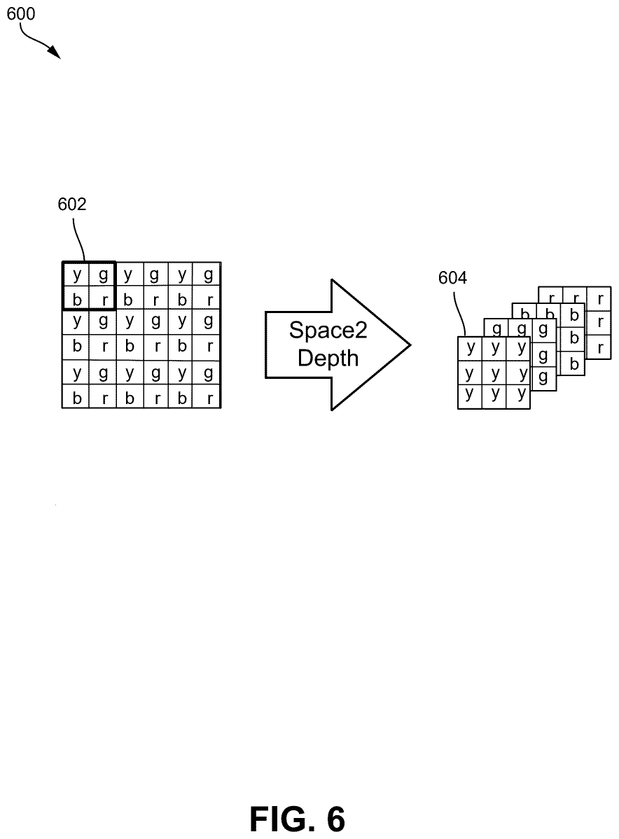

FIG. 6 is an example block diagram 600 illustrating a hyperspace transform, such as the hyperspace transform performed by the hyperspace transform engine 506 of FIG. 5. The hyperspace transform includes receiving an input, such as image 602. Image 602 is represented in FIG. 6 as a 6×6 grid of color channels y, g, b, and r. A hyperspace transform engine can perform a space2depth transformation of the image 602 to shift pixel arrangements of the one or more images across channels as patches 604. The patches 604 can be applied to a 2D convolution layer (e.g., conv2d) with a ReLU to generate a hyperspace map associated with features of the image 602.

In some examples, the hyperspace transform can be performed using multi-layered architecture such as the patch embedding 507 of FIG. 5. The multiple conv2d and ReLU layers can extract features from patches 604 to generate the hyperspace map.

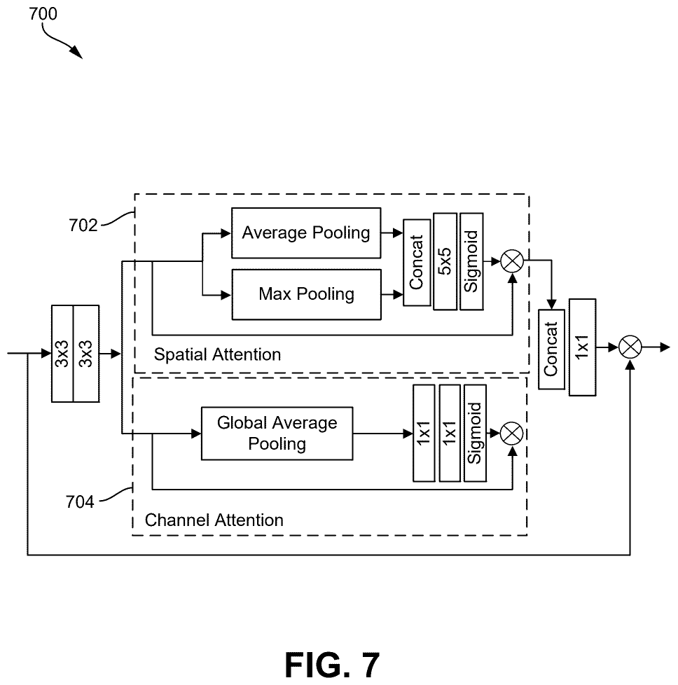

FIG. 7 is an example block diagram representing an example of a spatial channel attention engine 700. The spatial channel attention engine 700 includes a spatial attention block 702 and a channel attention block 704.

The spatial channel attention engine 700 receives as input a hyperspace map. For example, the spatial channel attention engine 700 can receive a hyperspace map from a hyperspace transform engine, such as the hyperspace transform engine 506 from FIG. 5. The spatial channel attention engine 700 applies spatial channel attention (e.g., dual attention) along spatial dimensions and across channel dimensions of the patches of the hyperspace map. For example, the patches 604 of FIG. 6 are dimensioned 3×3. The spatial channel attention engine 700 can apply spatial channel attention across a 3×3 spatial window. The spatial channel attention engine 700 can generate feature weight maps (e.g., saliency maps) by assigning values to features of the hyperspace map based on relevancy of the feature to a target machine learning model.

For example, a target machine learning model for performing lane assist functions can determine that features associated with lane markings are more relevant than features associated with road signs. The spatial attention engine can assign high values to features of the hyperspace map associated with lane markings (e.g., solid white lines, yellow lines, diamond symbols, arrows, etc.) and low values to other features irrelevant to lane assist such as foliage, signs, the sky, etc.

The spatial attention block 702 can provide high frequency regions to a max pooling function and the low frequency regions to an average pooling function. The spatial attention block 702 can concatenate the outputs of the max pooling function and the average pooling function to generate spatial feature weight maps. The feature weight maps can include values between 0.0 and 1.0 which are then multiplied with input features (e.g., the hyperspace map) to enhance features relevant to a target machine learning model. In some examples, the spatial attention block 702 can perform a 5×5 convolution and sigmoid activation on the outputs of the average pooling function and the max pooling function to generate the feature weight maps.

The channel attention block 704 can apply a global average pooling function, 1×1 convolutions, and a sigmoid activation to generate channel feature weight maps. The channel attention block 704 multiplies the channel feature weight maps with input features to generate enhanced features relevant to the target machine learning model.

The spatial channel attention engine 700 can be fine-tuned based on the target machine learning model. For example, the fine tuning can include using a backpropagation algorithm, loss function, or other training algorithms to fine-tune the spatial attention block 702 and channel attention block 704 to assign higher scores to features relevant to the task performed by the target machine learning model. The spatial channel attention layer can be fine-tuned for particular machine learning models.

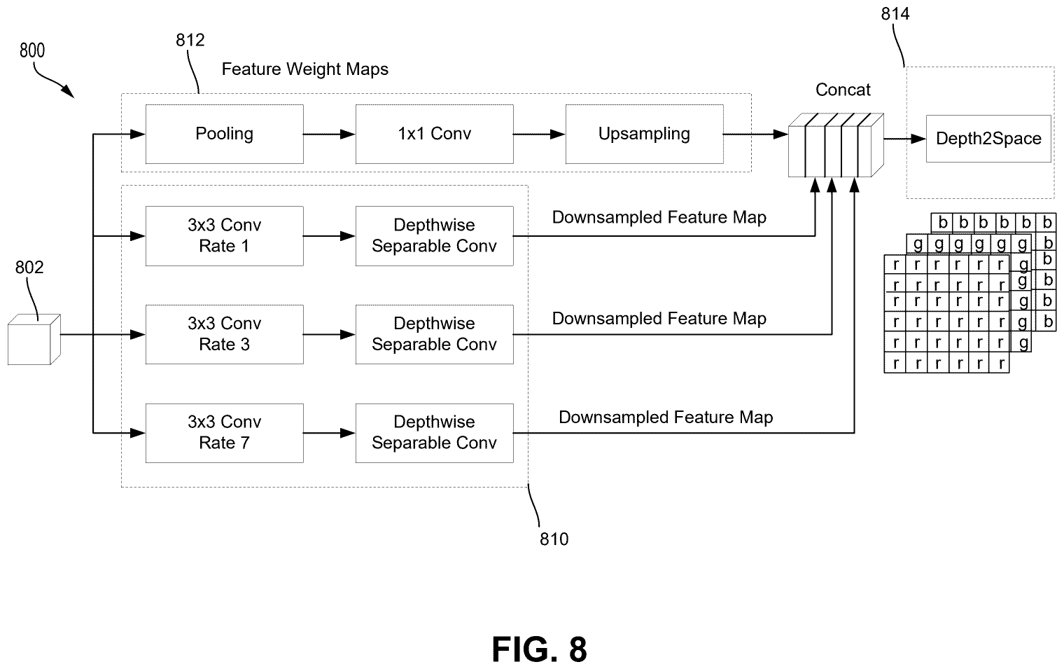

FIG. 8 is a block diagram 800 represents a weighted pooling engine 812 and a noise filter 810 for spatial restoration using a spatial restoration engine 814. The diagram includes a hyperspace map 802 (e.g., feature map) which is received by the noise filter 810 and the weighted pooling engine 812. The noise filter 810 can use a set of dilated convolutions on the hyperspace map 802 (e.g., the hyperspace map generated using a hyperspace transform). For example, the dilated convolutions can have a dilation rate of 1, 3, and 7. The noise filter 810 can apply a convolutional range gaussian filter by using a feature weight map from a spatial channel attention engine (e.g., the spatial channel attention engine 700 from FIG. 7) to reduce outlier noise and adversarial noise (N). The noise filter can reduce adversarial noise in multiple spatial and frequency domains from input features (I) as N=I−F(I). The noise filter 810 can concatenate outputs of the dilated convolutions of the hyperspace map 802 to generate concatenated downsampled feature maps.

The weighted pooling engine 812 can perform feature boosting of the features of the hyperspace map that are relevant to the target machine learning model by using a feature weight map from a spatial channel attention engine (e.g., the spatial channel attention engine 700 of FIG. 7) to perform selective pooling downsampling of the feature weights maps using adaptive thresholding of frequency components.

The spatial restoration engine 814 processes concatenated hyperspace maps associated with the noise filter 810 and the downsampled feature weight maps of the weighted pooling engine 812. The spatial restoration engine 814 can process the concatenated hyperspace maps to transform the concatenated feature maps into a spatial dimension using a Depth2Space (D2S) operation. The spatial restoration engine 814 can use the Depth2Space operation to generate a reduced resolution image for a target machine learning model based on the concatenated downsampled hyperspace maps.

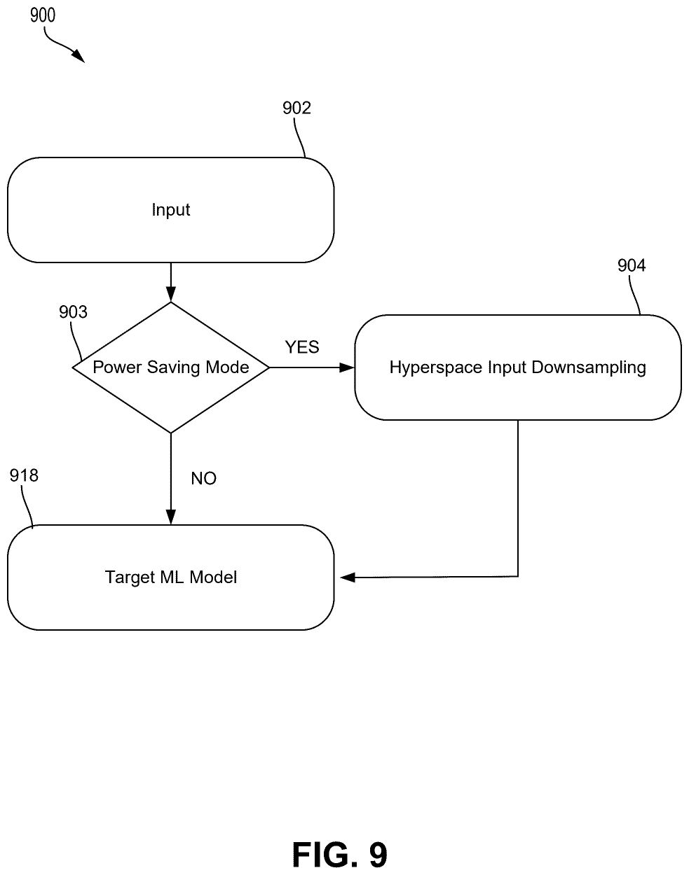

FIG. 9 is an example process 900 for applying a hyperspace downsampler when using a device in a power saving mode. The example process 900 includes receiving an input 902. The input 902 can include various sensor data, such as sensor data collected using the sensor suite 404 of FIG. 4 (e.g., LIDAR data, RADAR data, images, etc.). In one illustrative example, the input 902 is an image or multiple images.

The process 900 includes determining whether a device associated with the hyperspace downsampler is in power saving mode 903. In some cases, the power saving mode 903 can include the device using less than all available resources and/or services, such as using only resources and services which have lesser utilization of computation cores from a processing unit (e.g., turning off ADAS features, monitoring services, gesture detection, etc.). When the device is not in power saving mode 903 (e.g., the device is in full operating mode), the device can determine not to use hyperspace input downsampling to utilize all (or most) computational resources. The device can provide the input 902 to a target machine learning model 918. When the device is in power saving mode 903, the device can determine to use hyperspace input downsampling 904 to conserve computational resources.

In further examples, the device can determine to use hyperspace downsampling in other scenarios. For example, when the device is conserving computational resources to perform other operations. In another example, the device can use hyperspace downsampling when the device detects a sensor collecting input data at higher resolutions than supported by the device.

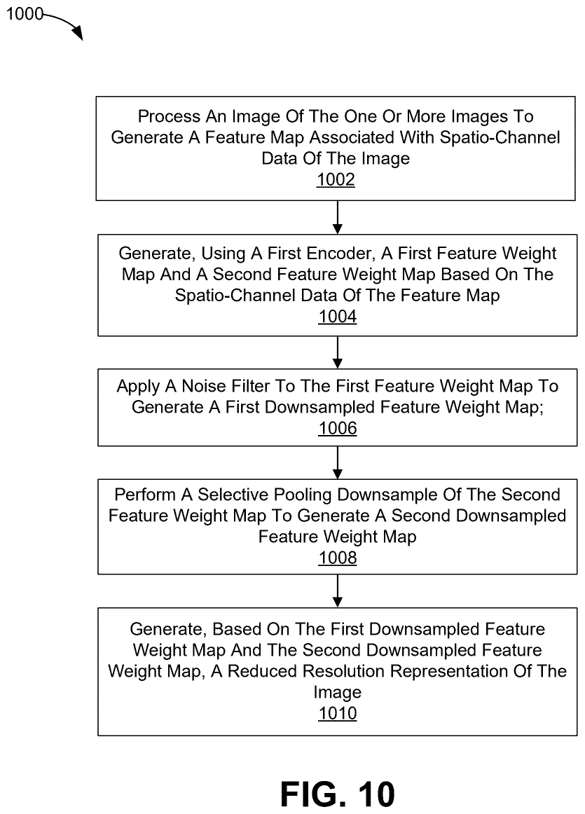

FIG. 10 is a flow diagram illustrating an example of a process 1000 for applying a hyperspace downsampler to downsample inputs. The process 1000 can be performed by a computing device (e.g., SOC 200 of FIG. 2, computing device or computing system 1100 of FIG. 11, etc.) or by a component or system (e.g., the neural networks of FIGS. 3A-3D, a chipset, one or more processors central processing units (CPUs), digital signal processors (DSPs), graphics processing units (GPUs), any other type of processor(s), any combination thereof, or other component or system) of the computing device. In some aspects, the computing device is a sub-component of a system, such as a camera system, a display system, a video coding system, an ADAS system, or other system. In some cases, the computing device can include one or more cameras configured to capture the one or more images. The operations of the process 1000 can be implemented as software components that are executed and run on one or more processors (e.g., processor 1110 of FIG. 11 or other processor(s)) of the computing device. Further, the transmission and reception of signals by the computing device in the process 1000 can be enabled, for example, by one or more antennas and/or one or more transceivers (e.g., wireless transceiver(s)).

At block 1002, the computing device (or component thereof) can process an image to generate a feature map (e.g., a hyperspace map, such as the hyperspace map (Xp) generated by the hyperspace transform engine 506 of FIG. 5) associated with spatio-channel data of the image. In some aspects, the computing device (or component thereof) can process the image to generate the feature map using a transformation to shift pixel arrangements of the image across channels as patches (e.g., as described with respect to FIG. 6). In such aspects, the feature map is based on the patches.

At block 1004, the computing device (or component thereof) can generate, using a first encoder (e.g., the spatial channel attention engine 508 of FIG. 5, the spatial channel attention engine 700 of FIG. 7, the spatial attention block 702 and/or the channel attention block 704 of FIG. 7, etc.), a first feature weight map (e.g., the weight map xₐₜₜₙ output to the noise filter 510 of FIG. 5) and a second feature weight map (e.g., the weight map xₐₜₜₙ output to the weighted pooling engine 512 of FIG. 5) based on the spatio-channel data of the feature map.

In some aspects, the computing device (or component thereof) can assign, using a second encoder (e.g., the spatial attention block 702 and/or the channel attention block 704 of FIG. 7), scores to a first plurality of features of the first feature weight map and a second plurality of features of the second feature weight map. In some cases, the computing device (or component thereof) can remove features from the first plurality of features and the second plurality of features based on the scores. For example, the spatial channel attention engine can ignore or otherwise remove features associated with the lower scores. In such aspects, the first feature weight map and the second feature weight map are instances of a same feature weight map.

At block 1006, the computing device (or component thereof) can apply a noise filter (e.g., the noise filter 510 of FIG. 5, the noise filter 810 of FIG. 8, etc.) to the first feature weight map to generate a first downsampled feature weight map. In some aspects, the computing device (or component thereof) can apply the noise filter to the first feature weight map using a plurality of dilated convolutions and a convolutional range-gaussian filter to reduce outlier noise in the first feature weight map (e.g., as described with respect to FIG. 5 and/or FIG. 8).

At block 1008, the computing device (or component thereof) can perform a selective pooling downsample (e.g., using the weighted pooling engine 512 of FIG. 5, the weighted pooling engine 812 of FIG. 8, etc.) of the second feature weight map to generate a second downsampled feature weight map. In some aspects, the computing device (or component thereof) can perform the selective pooling downsample using an adaptive threshold on frequency components of the second feature weight map.

At block 1010, the computing device (or component thereof) can generate, based on the first downsampled feature weight map and the second downsampled feature weight map, a reduced resolution representation of the image (e.g., using the spatial restoration engine 514 of FIG. 5).

In some aspects, the computing device (or component thereof) can provide the reduced resolution representation of the image to a machine learning model to perform one or more tasks (e.g., object detection, semantic segmentation, pose estimation, and/or other task(s)) associated with objects represented in the reduced resolution representation. In some aspects, the machine learning model is a deep neural network. In some cases, the machine learning model is trained using on-device training.

In some aspects, the computing device (or component thereof) can determine to downsample the image based on a power saving mode of the apparatus (e.g., as described with respect to FIG. 9). In some cases, the computing device (or component thereof) can adapt parameters of the first encoder based on a target machine learning model. For instance, the parameters of the first encoder (e.g., the spatial channel attention engine) can be fine-tuned (e.g., during on-device or off device training) using a backpropagation algorithm, loss function, or other training algorithm/function to fine tune parameters of the encoder to assign higher scores to features relevant to the task (e.g., object detection, semantic segmentation, pose estimation, and/or other task(s)) performed by the target machine learning model.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1100 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 1100 also includes a connection 1105 that couples various system components including system memory 1115, such as read-only memory (ROM) 1120 and random-access memory (RAM) 1125 to processor 1110. Computing system 1100 can include a cache 1112 of high-speed memory connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 can essentially be a completely self-contained computing system, containing multiple cores or processors, a bus, memory controller, cache, etc. A multi-core processor can be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 can also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc. When the code that defines such software is executed by the processor 1110, the code causes the system to perform a function. In some aspects, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:
Aspect 1. An apparatus for image downsampling, the apparatus comprising: one or more memories configured to store one or more images; and one or more processors coupled to the one or more memories and configured to: process an image of the one or more images to generate a feature map associated with spatio-channel data of the image; generate, using a first encoder, a first feature weight map and a second feature weight map based on the spatio-channel data of the feature map; apply a noise filter to the first feature weight map to generate a first downsampled feature weight map; perform a selective pooling downsample of the second feature weight map to generate a second downsampled feature weight map; and generate, based on the first downsampled feature weight map and the second downsampled feature weight map, a reduced resolution representation of the image.
Aspect 2. The apparatus of Aspect 1, wherein the one or more processors are configured to: apply the noise filter to the first feature weight map using a plurality of dilated convolutions and a convolutional range-gaussian filter to reduce outlier noise in the first feature weight map.
Aspect 3. The apparatus of any of Aspects 1 or 2, wherein the one or more processors are configured to: process the image to generate the feature map using a transformation to shift pixel arrangements of the image across channels as patches, wherein the feature map is based on the patches.
Aspect 4. The apparatus of any of Aspects 1 to 3, wherein the one or more processors are configured to: assign, using a second encoder, scores to a first plurality of features of the first feature weight map and a second plurality of features of the second feature weight map; and remove features from the first plurality of features and the second plurality of features based on the scores.
Aspect 5. The apparatus of Aspect 4, wherein the first feature weight map and the second feature weight map are instances of a same feature weight map.
Aspect 6. The apparatus of any of Aspects 1 to 5, wherein the one or more processors are configured to: perform the selective pooling downsample using an adaptive threshold on frequency components of the second feature weight map.
Aspect 7. The apparatus of any of Aspects 1 to 6, wherein the one or more processors are configured to: provide the reduced resolution representation of the image to a machine learning model to perform one or more tasks associated with objects represented in the reduced resolution representation.
Aspect 8. The apparatus of Aspect 7, wherein the machine learning model is a deep neural network.
Aspect 9. The apparatus of any of Aspects 7 or 8, wherein the machine learning model is trained using on-device training.
Aspect 10. The apparatus of any of Aspects 1 to 9, wherein the one or more processors are configured to: determine to downsample the image based on a power saving mode of the apparatus.
Aspect 11. The apparatus of any of Aspects 1 to 10, wherein the feature map is a hyperspace map.
Aspect 12. The apparatus of any of Aspects 1 to 11, wherein the one or more processors are configured to: adapt parameters of the first encoder based on a target machine learning model.
Aspect 13. The apparatus of any of Aspects 1 to 12, wherein the apparatus is a sub-component of a system, and wherein the system comprises a camera system, a display system, or a video coding system.
Aspect 14. The apparatus of any of Aspects 1 to 13, further comprising one or more cameras configured to capture the one or more images.
Aspect 15. A method for image downsampling, the method comprising: processing an image to generate a feature map associated with spatio-channel data of the image; generating, using a first encoder, a first feature weight map and a second feature weight map based on the spatio-channel data of the feature map; applying a noise filter to the first feature weight map to generate a first downsampled feature weight map; performing a selective pooling downsample of the second feature weight map to generate a second downsampled feature weight map; and generating, based on the first downsampled feature weight map and the second downsampled feature weight map, a reduced resolution representation of the image.
Aspect 16. The method of Aspect 15, further comprising: applying the noise filter to the first feature weight map using a plurality of dilated convolutions and a convolutional range-gaussian filter to reduce outlier noise in the first feature weight map.
Aspect 17. The method of any of Aspects 15 or 16, further comprising: processing the image to generate the feature map using a transformation to shift pixel arrangements of the image across channels as patches, wherein the feature map is based on the patches.
Aspect 18. The method of any of Aspects 15 to 17, further comprising: assigning, using a second encoder, scores to a first plurality of features of the first feature weight map and a second plurality of features of the second feature weight map; and removing features from the first plurality of features and the second plurality of features based on the scores.
Aspect 19. The method of Aspect 18, wherein the first feature weight map and the second feature weight map are instances of a same feature weight map.
Aspect 20. The method of any of Aspects 15 to 19, further comprising: performing the selective pooling downsample using an adaptive threshold on frequency components of the second feature weight map.
Aspect 21. The method of any of Aspects 15 to 20, further comprising: providing the reduced resolution representation of the image to a machine learning model to perform one or more tasks associated with objects represented in the reduced resolution representation.
Aspect 22. The method of Aspect 21, wherein the machine learning model is a deep neural network.
Aspect 23. The method of any of Aspects 21 or 22, wherein the machine learning model is trained using on-device training.
Aspect 24. The method of any of Aspects 15 to 23, further comprising: determining to downsample the image based on a power saving mode of a device.
Aspect 25. The method of Aspect 24, wherein the device is a sub-component of a system, and wherein the system comprises a camera system, a display system, or a video coding system.
Aspect 26. The method of any of Aspects 15 to 25, wherein the feature map is a hyperspace map.
Aspect 27. The method of any of Aspects 15 to 26, further comprising: adapting parameters of the first encoder based on a target machine learning model.
Aspect 28. A non-transitory computer-readable medium having stored thereon instructions that, when executed by at least one processor, cause the at least one processor to perform operations according to any of Aspects 15 to 27.
Aspect 29. An apparatus for image downsampling, the apparatus including one or more means for performing operations according to any of Aspects 15 to 27.

What is claimed is:

1. An apparatus for image downsampling, the apparatus comprising:
one or more memories configured to store one or more images; and
one or more processors coupled to the one or more memories and configured to:
process an image of the one or more images to generate a feature map associated with spatio-channel data of the image;
generate, using a first encoder, a first feature weight map and a second feature weight map based on the spatio-channel data of the feature map;
apply a noise filter to the first feature weight map to generate a first downsampled feature weight map;
perform a selective pooling downsample of the second feature weight map to generate a second downsampled feature weight map; and
generate, based on the first downsampled feature weight map and the second downsampled feature weight map, a reduced resolution representation of the image.

2. The apparatus of claim 1, wherein the one or more processors are configured to:
apply the noise filter to the first feature weight map using a plurality of dilated convolutions and a convolutional range-gaussian filter to reduce outlier noise in the first feature weight map.

3. The apparatus of claim 1, wherein the one or more processors are configured to:
process the image to generate the feature map using a transformation to shift pixel arrangements of the image across channels as patches, wherein the feature map is based on the patches.

4. The apparatus of claim 1, wherein the one or more processors are configured to:
assign, using a second encoder, scores to a first plurality of features of the first feature weight map and a second plurality of features of the second feature weight map; and
remove features from the first plurality of features and the second plurality of features based on the scores.

5. The apparatus of claim 4, wherein the first feature weight map and the second feature weight map are instances of a same feature weight map.

6. The apparatus of claim 1, wherein the one or more processors are configured to:
perform the selective pooling downsample using an adaptive threshold on frequency components of the second feature weight map.

7. The apparatus of claim 1, wherein the one or more processors are configured to:
provide the reduced resolution representation of the image to a machine learning model to perform one or more tasks associated with objects represented in the reduced resolution representation.

8. The apparatus of claim 7, wherein the machine learning model is a deep neural network.

9. The apparatus of claim 7, wherein the machine learning model is trained using on-device training.

10. The apparatus of claim 1, wherein the one or more processors are configured to:
determine to downsample the image based on a power saving mode of the apparatus.

11. The apparatus of claim 1, wherein the feature map is a hyperspace map.

12. The apparatus of claim 1, wherein the one or more processors are configured to:
adapt parameters of the first encoder based on a target machine learning model.

13. The apparatus of claim 1, wherein the apparatus is a sub-component of a system, and wherein the system comprises a camera system, a display system, or a video coding system.

14. The apparatus of claim 1, further comprising one or more cameras configured to capture the one or more images.

15. A method for image downsampling, the method comprising:
processing an image to generate a feature map associated with spatio-channel data of the image;
generating, using a first encoder, a first feature weight map and a second feature weight map based on the spatio-channel data of the feature map;
applying a noise filter to the first feature weight map to generate a first downsampled feature weight map;
performing a selective pooling downsample of the second feature weight map to generate a second downsampled feature weight map; and
generating, based on the first downsampled feature weight map and the second downsampled feature weight map, a reduced resolution representation of the image.

16. The method of claim 15, further comprising:
applying the noise filter to the first feature weight map using a plurality of dilated convolutions and a convolutional range-gaussian filter to reduce outlier noise in the first feature weight map.

17. The method of claim 15, further comprising:
processing the image to generate the feature map using a transformation to shift pixel arrangements of the image across channels as patches, wherein the feature map is based on the patches.

18. The method of claim 15, further comprising:
assigning, using a second encoder, scores to a first plurality of features of the first feature weight map and a second plurality of features of the second feature weight map; and
removing features from the first plurality of features and the second plurality of features based on the scores.

19. The method of claim 15, further comprising:
performing the selective pooling downsample using an adaptive threshold on frequency components of the second feature weight map.

20. The method of claim 15, further comprising:
providing the reduced resolution representation of the image to a machine learning model to perform one or more tasks associated with objects represented in the reduced resolution representation.
